(19) United States
(12) Patent Application Publication
(10) Pub. No.: US 2026/0274234 A1
(43) Pub. Date: Sep. 17, 2026

(54) ELECTROMECHANICAL BRAKING MECHANISM FOR A MOTOR VEHICLE

(71) Applicants: thyssenkrupp Presta AG, Eschen (LI); thyssenkrupp AG, Essen (DE)

(72) Inventors: Tamas UNGVARI, Budapest (HU); Dennis PONGRATZ, Koblach (AT)

(73) Assignees: thyssenkrupp Presta AG, Eschen (LI); thyssenkrupp AG, Essen (DE)

(21) Appl. No.: 19/165,097

(22) PCT Filed: Oct. 24, 2023
(86) PCT No.: PCT/EP2023/079622

§ 371 Date: Sep. 12, 2025

(30) Foreign Application Priority Data
Mar. 15, 2023 (BE) BE 2023/5186

(51) Int. Cl. B60T 13/74; F16D 65/18; F16D 121/24; F16D 125/48

(52) U.S. Cl. CPC B60T 13/746; F16D 65/183; B60T 2270/402; F16D 2121/24; F16D 2125/48

(57) ABSTRACT

An electromechanical brake device for a motor vehicle comprises a drive carrier to which an electric motor and an actuating device are attached, which actuating device is coupled in a geared manner to a motor shaft and by which a brake part is adjustable, wherein the motor has a motor housing, in which the motor shaft which extends in the axial direction is mounted in a front-side bearing cap and projects axially from it, wherein the motor housing is fixed to the drive carrier. In order to enable improved production and assembly, and to keep the installation space and weight low, the drive carrier may have a recess, in which the motor housing can be received in a positively locking manner in the axial and radial direction, wherein the motor housing can be braced on the front side against an axial support surface of the recess.

### PRIOR ART

The invention relates to an electromechanical brake device for a motor vehicle, comprising a drive carrier to which an electric motor and an actuating device are attached, which actuating device is coupled in a geared manner to a motor shaft and by which a brake part is adjustable, wherein the motor has a motor housing, in which the motor shaft which extends in the axial direction is mounted in a front-side bearing cap and projects axially from it, wherein the motor housing is fixed to the drive carrier.

Such a brake device of a motor vehicle is configured as a friction brake, in which a brake part which is supported on the chassis and is fixed relative to the rotation of the wheel to be braked can be brought by means of an actuating device into brake engagement with a counter-brake part which rotates with the wheel. During the brake engagement, friction contact is produced between the brake part and the counter-brake part, wherein the brake torque produced by friction is greater, the higher the adjustment force is which is exerted by the actuating device in the adjustment direction.

The disk brakes which are known in principle and in which the counter-brake part is formed by a brake disk which rotates with the wheel and is axially reached around on both sides by a brake caliper are a widespread design. By means of at least one preferably linear actuating drive which is axially supported on the brake caliper, a brake part, usually a brake pad, can be adjusted in an axial adjustment direction and thereby brought into friction contact with an axial side of the brake disk, wherein, during the brake engagement, the brake disk is frictionally clamped between the adjusted brake part and a further brake part which is supported axially opposite on the brake caliper.

It is known from DE 10 2017 123 266 A1 that the actuating device has two actuating drives arranged in series in the adjustment direction. Each of the actuating drives has a drive-side drive element and an output-side output element which is linearly adjustable relative to the former in the axial adjustment direction. For the realization of an adjustment movement, each drive element has a drive wheel, preferably a transmission wheel such as a gearwheel or the like, which is rotationally drivable about its axis by an electric motor, the actuating motor. The rotation of the drive wheel is converted in the actuating drive in each case into a relative adjustment movement or an actuating stroke of the output element relative to the drive element in the axial adjustment direction. In the prior art in question, the two drive wheels of the first and second actuating drive are arranged coaxially on a common axis lying in the axial adjustment direction.

An actuating drive in each case forms a lifting or adjusting device which is axially effective in the adjustment direction. For example, an actuating drive can have a spindle drive, in which the drive element has a spindle nut, and the output element has a threaded spindle engaging therein, or vice versa. It is also possible to use other designs of actuating drives which can comprise, for example, ramp bearings, cam disks, tilting pin arrangements or the like, and likewise convert a rotation of the drive element into a linear adjustment of the output element.

The actuating device and the motor(s) are mounted on a drive carrier such that a transmission wheel, for example a gearwheel, mounted on a rotationally drivable motor shaft of the motor, is in gear engagement with the drive wheel of an actuating drive, as described in the abovementioned document DE 10 2017 123 266 A1. The drive carrier is connected to the brake caliper. It has a plate-shaped mounting portion which extends flatly and on which the motor is fixed in such a way that the motor shaft and the axis parallel to it of the actuating device are perpendicular with respect to the drive carrier.

The motor has a motor housing, in which the motor shaft including the rotor is mounted rotatably and which is connected to the drive carrier. The motor housing comprises a front-side bearing cap, through which the motor shaft is routed axially to the front toward the drive carrier. The bearing cap is connected to the motor housing which is connected to the drive carrier.

For smooth and low-wear operation, it is essential that the motor shaft is oriented in parallel at a defined spacing from the axis of the actuating drive, with the result that optimum gear engagement is ensured. This requires that the motor is precisely positioned and securely fixed on the drive carrier relative to the actuating drive on the drive carrier. The effort involved in production and assembly, as well as the installation space required and the weight, should be as low as possible. However, a disadvantage of the known embodiments is that the assembly and alignment of the motor housing on the drive carrier is extensive.

In view of the problem described above, it is an object of the present invention to enable improved production and assembly, and to keep the installation space and the weight low.

### SUMMARY OF THE INVENTION

Said object is achieved according to the invention by the brake device having the features of claim 1. Advantageous developments result from the dependent claims.

In the case of an electromechanical brake device for a motor vehicle, comprising a drive carrier to which an electric motor and an actuating device are attached, which actuating device is coupled in a geared manner to a motor shaft and by which a brake part is adjustable, wherein the motor has a motor housing, in which the motor shaft which extends in the axial direction is mounted in a front-side bearing cap and projects axially from it, wherein the motor housing is fixed to the drive carrier, it is provided according to the invention that the drive carrier has a recess, in which the motor housing can be received in a positively locking manner in the axial and radial direction, wherein the motor housing can be braced on the front side against an axial support surface of the recess.

The recess provides a receptacle for the motor, in which the motor housing can be received in a defined manner such that it is oriented in an axially and radially defined manner relative to the drive carrier. The recess has an opening which passes through the drive carrier and through which the motor shaft is guided perpendicularly by the drive carrier.

The support surface can be formed on a support projection which projects radially inward into the opening of the recess, for example on a step or the like arranged at the edge of the opening. The open cross section of the recess is adapted to the outer cross section of the motor housing in such a way that it can be introduced axially—by definition toward the front in the direction of the motor axis defined by the motor shaft—into the recess with little radial play until it comes axially into contact with the support surface. Here, the motor shaft protrudes on that side of the drive carrier which faces away from the motor.

The bearing cap arranged on the front end side of the motor housing can be supported against the support surface and braced with the motor housing.

One advantage is that the motor housing is supported in a positively locking manner in the radial direction when inserted in the recess and is also supported in a positively locking manner in the axial direction when it it comes into contact with the support surface. Thus, the motor received in the recess is positioned in a spatially defined manner relative to the drive carrier. Bracing for fixing the motor can take place after insertion into the recess. As a result, the assembly is advantageously simplified, and a defined gear engagement with the actuating device can be provided simply, for example via transmission wheels of the motor shaft and the actuator which are in engagement with one another.

It is possible that the support surface is formed on a projection projecting radially inward in the recess. The projection can preferably have a peripheral step or the like which runs around inside in the recess at least over a part of the periphery and on which the support surface is formed parallel to the flat extent of a mounting portion of the drive carrier.

It is preferred that the bearing cap is attached on the front side to the motor housing. The bearing cap can initially be provided here as a separate part and can be assembled with the motor housing after the insertion of the rotor with the motor shaft. This enables the motor to be mounted in an efficient manner.

It can be provided that the bearing cap is supported axially against the support surface. The bearing cap attached axially at the front to the motor housing can lie against the support surface with its front end side facing away from the motor housing. The bearing cap is connected to the motor housing on its rear side facing away axially from the front side.

It is advantageous that the bearing cap can be braced between the support surface and the motor housing. Here, the bearing cap has at least one portion which is arranged axially between the motor housing and the support surface. Thus, the bearing cap can be axially braced against the motor housing by virtue of the fact that it is braced against the support surface. In other words, the bearing cap is situated at least in sections in the force flow of the bracing of the motor housing to the drive carrier. This allows the fixing of the motor to the drive carrier and the fixing of the bearing cap to the motor housing during bracing in a single assembly step, with the result that the effort is advantageously reduced.

For example, the bearing cap can have an axial shoulder which is inserted into an axial opening of the motor housing, and a peripheral collar which projects radially outward over the cross section of the opening. The collar can have substantially the same outer cross section as the motor housing, and is arranged axially between the support surface and the motor housing. When the motor housing is braced against the support surface, this allows the bearing cap at the same time to be supported on the support surface and fixed to the motor housing. One advantage here is that the bearing cap only has to be provisionally connected to the motor housing before the motor is installed in the brake device, and the final fixing can be carried out in one assembly step when the motor is braced to the drive carrier. The bracing thus fulfills a double function of fixing the motor to the drive carrier and fixing the bearing cap to the motor housing. For example, the bearing cap can be inserted merely in a non-positive manner into the motor housing with an axial shoulder, or can be plugged onto the motor housing. This eliminates the need for costly screw, welding or other joining connections between the bearing cap and the motor housing, with the result that the construction of the motor is simplified and weight can be saved.

It can preferably be provided that the motor housing has a flange element which is spaced apart axially from the end side and projects radially beyond the recess.

The flange element protrudes radially outward from the motor housing and projects beyond the recess. It can be connected to the drive carrier. To this end, fastening means can be provided which can be connected outside the recess to the drive carrier in order to brace the motor housing axially against an outer side of the brake housing. For example, several axial flange holes can preferably be provided in the flange element distributed over the periphery, through which fastening elements such as screws or the like can be guided and can be screwed into corresponding threaded holes in the drive carrier. By virtue of the fact that the flange element is at an axial spacing from the front end side of the bearing cap, the motor housing which dips into the recess can be braced with the bearing cap on the front side against the support surface arranged in the recess by the axial bracing of the flange element against the drive carrier. In this way, the motor can be fixed by the flange element in the position defined by the recess on the drive carrier, and, at the same time, the bearing cap can be braced and firmly connected to the motor housing as a result.

The axial distance of the flange element from the front side of the bearing cap mounted on the front side at the front of the motor housing is preferably greater than the depth of the recess, measured from the support surface to the outer side of the drive carrier in the region of the flange element. This allows the bearing cap to be clamped in axially between the support surface and the motor housing by bracing the flange element. The advantage is that the bearing cap can be securely connected to the motor housing without additional connecting means by connecting the motor housing to the drive housing. This allows the motor to be of simpler and lighter design.

It can be provided that the motor housing at least partially has a hollow cross section, on which the bearing cap can be fixed in a positively locking manner. The motor housing can, for example, be of pot-shaped or cup-shaped design, and can be closed axially at the front by the bearing cap attached to it. The motor shaft having the rotor can be mounted in an end region on the inner side in the motor housing, and can be rotatably mounted with its other end region in the bearing cap and guided through the latter to the outside. The hollow cross section can, for example, have a substantially cylindrical tube portion, on the open end side of which the bearing cap can be fixed by axial bracing. For example, a cylindrical extension of the bearing cap can be inserted in a positively locking manner into the opening of the hollow cross section, and a substantially annular collar can be clamped in the manner described above between the support surface and the end side of the tube portion.

It can be advantageous that the motor housing, the bearing cap and/or the drive carrier comprises/comprise a cast part. The cast part can be an injection molded part made from a thermoplastic, which can optionally be fiber-reinforced to increase the strength, or a die-cast part made from a metallic material, for example from aluminum, magnesium or zinc alloys. Using the casting method, complex shapes can be realized efficiently. For example, the recess according to the invention and possibly further functional elements can be molded in one piece on the drive carrier. Correspondingly, the flange element and possibly further functional elements can be molded in one piece on the motor housing. For example, an extension for connection to the motor housing, a bearing seat for the motor shaft or the like can be molded in one piece on the bearing cap.

It is possible that an elastic retaining element and/or sealing element are/is arranged between the recess and the motor housing. For example, an elastically deformable O-ring made from a rubber or polymer material can be radially clamped in between a circumferential inner surface of the recess and an outer surface of the motor housing. As a result, the motor housing can be held in position on the drive carrier in a non-positive or frictional manner by simply plugging it axially into the recess, as a result of which the subsequent bracing can be simplified. It can be advantageously provided that an O-ring is received in a groove, running over the periphery, of the recess or the motor housing, and is thus held in a positively locking manner in the axial direction.

In addition, an O-ring or another elastic sealing element can effectively seal the motor housing in the recess against ingress of moisture or contaminants.

Preferably, it can be provided that the drive carrier has at least two recesses. In each of the recesses, a motor can be fixed, each of which can drive an actuating drive of the actuating device. This makes it possible to mount two motors to drive two actuating drives of the actuating device on the drive carrier. It is advantageous that, according to the invention, both motors can be easily and safely positioned and mounted relative to the actuating drives.

One advantageous embodiment can provide that the brake device comprises an actuating device and a brake part which is connected thereto, is adjustable along an axis by the actuating device and can be brought into brake engagement with a counter-brake part, wherein the actuating device has a first actuating drive and a second actuating drive which is coupled in series thereto, wherein the first actuating drive has a rotationally drivable first drive wheel, and the second actuating drive has a rotationally drivable second drive wheel which is coaxial with the first drive wheel, wherein a clutch device is arranged between the first drive wheel and the second drive wheel.

The actuating device is drivable by at least one electric actuating motor. The latter is preferably in gear engagement with at least one drive wheel. Preferably, one actuating motor can be provided for each of the first and the second drive wheel. According to the invention, the actuating motor or motors can be activated by a wheel brake control unit assigned to the brake device.

It can be provided that the clutch device is configured as a friction clutch having a friction element which, during engagement of the clutch, is connectable in a frictionally locking manner to a counter-friction element.

In the following text, the first and the second drive wheel are together also referred to as the two drive wheels or as the drive wheels for short.

The drive wheels can each be designed as a gearwheel, for example as a spur gear, or as a pulley wheel or toothed belt pulley or worm gear, with the result that generally a transmission wheel, by way of which a drive torque from an electric actuating motor can be coupled into the actuating drive, is provided.

A friction clutch is implemented between the drive wheels. Said friction clutch comprises a friction element which is connected torque-lockingly to one of the drive wheels, and a corresponding counter-friction element, which is connected in a torque-locking manner to the respective other drive wheel. The friction element can be brought into frictionally locking coupling engagement with the counter-friction element in any relative angular position. As opposed to a positively locking latching connection, a purely non-positive clutch is implemented here. As a result, the relative position of the drive wheels with respect to one another can be predefined continuously, in contrast to the discrete latching steps of a latching connection. Accordingly, a uniform, continuous adjustment of the second actuating drive relative to the first actuating drive is enabled, and the air gap can be continuously adjusted. This is particularly advantageous with regard to uniform tracking of the optimum working point of the brake device to the continuous wear of the brake part during operation, i.e. the continuous wear of the brake pad. Compared to an only stepped adjustment option, a continuously improved response behavior of the brake device, and thus increased operational reliability and greater operating comfort, can be realized.

Another advantage in comparison to a latching clutch lies in that, for actuating and releasing the clutch device, essentially no axial relative movement is required between the clutch elements which are in clutch engagement, for example between the drive wheels or the latching elements which inevitably have to be movable relative to one another in order to produce and release the latchable positively locking connection. In contrast, the pure non-positive connection between the friction element and counter-friction element according to the invention can be simply predetermined by the applied axial actuation force, wherein the friction element and counter-friction element do not have to be moved axially relative to each other. This enables a simpler and more reliable structural design of the clutch device.

It is preferably provided that the friction clutch has a clutch torque which can be specified in a defined manner. The clutch torque indicates the maximum differential torque which can be transmitted by the frictionally locking connection in the clutch engagement in a non-positive manner between the friction element and the counter-friction element. When the clutch torque is exceeded, the clutch device slips such that the two drive wheels are rotated relative to each other. One advantage here is that the friction clutch according to the invention continuously slips, with the result that an improved, homogeneous readjustment of the air gap is enabled. Moreover, no axial deviating movements of latching elements, as in the case of the known latching clutch, have to be structurally considered and absorbed.

It is advantageous that the friction element and the counter-friction element are arranged coaxially. The coaxial arrangement corresponds here to the coaxial arrangement of the drive wheels. The friction element and the counter-friction element can be arranged in a structurally simple manner and in a compact overall design in the region of those end sides of the drive wheels which are directed axially counter to one another. Due to the pure non-positive connection generated by the clutch, as described above, no movable parts whatsoever are required.

In one advantageous embodiment, it can be provided that the friction element and the counter-friction element are of conical design. The friction element can have a conical portion converging at least in sections in the axial adjustment direction and having a conical friction surface, which can be designed as an outer cone or inner cone, and which with a corresponding conical portion on the counter-friction element, which is correspondingly designed in the opposite direction as an inner cone or outer cone and has a conical counter-friction surface. To produce the engagement of the clutch, the outer cone enters the inner cone, wherein the conical friction and counter-friction surfaces are loaded in a frictionally locking manner against each other by an axial actuation force of the clutch. One advantage here is that the axially acting actuation force of the clutch can be converted by the cone into the normal force acting between the conical friction surfaces during the friction contact. Thus, a relatively small axial actuation force can be converted by a relatively shallow slope into a greater normal force in the friction contact, as a result of which a high clutch torque can already be realized by a relatively small axial actuation force of the clutch.

As an alternative or in addition to the abovementioned embodiment, it can be provided that the friction element and the counter-friction element are of planar design. The mutually corresponding friction surfaces are designed at least in sections here as flat axial surfaces, in a similar manner to a disk clutch. A space-saving arrangement is made possible, especially if only a relatively small clutch torque is to be realized.

It can preferably be provided that the friction element and the counter-friction element are pre-loaded against each other. Preferably, the friction element and the counter-friction element are preloaded against each other elastically or resiliently. The friction and counter-friction surfaces are pressed against each other in the frictionally locking connection by way of a predetermined axial preload force. In order to generate the preload force, an elastic preload element can preferably be provided, for example a spring element or the like. The clutch torque of the friction clutch is determined by the actuation force acting perpendicularly with respect to the friction contact, i.e. the force applied axially between the friction and counter-friction element, with a greater preload force resulting in a greater clutch torque. This opens up the advantageous possibility of simply predetermining the clutch torque by the preload force exerted by the preload element. For example, in the case of a spring element which is flexible in the axial direction under pressure, such as a compression spring, the preload force exerted can be simply predetermined and adjusted by the spring constant and the compression of the spring.

The abovementioned embodiment can be advantageously realized in that the friction element and/or the counter-friction element are/is axially displaceable and supported against the first drive wheel or the second drive wheel via an axially acting spring element. The friction element or the counter-friction element are torque-lockingly and axially displaceably connected to the one drive wheel, for example via radially projecting drivers producing a non-positive connection which is effective in the circumferential direction. The spring element which is axially clamped in between the friction element or the counter-friction element and the one drive wheel and is preferably designed as an axially acting compression spring ensures that the friction or counter-friction element is preloaded axially against the corresponding counter-friction or friction element, which is axially supported on the other drive wheel, i.e. is axially pressed against it during the friction contact. The corresponding counter-friction or friction element is connected fixedly to the respective other drive wheel for conjoint rotation. It is also possible that, as an alternative or in addition, the counter-friction element is supported on one of the drive wheels via a spring element. One advantage of this arrangement is that this friction clutch can be incorporated between the drive wheels in a structurally simple and space-saving manner.

In one advantageous development, it is possible that the friction element and/or the counter-friction element are/is arranged in the first drive wheel or the second drive wheel. For example, it is possible to design the one drive wheel to be substantially drum-shaped, and therefore the friction or counter-friction element can be arranged in an interior space enclosed by the rotating gearwheel or gear rim. This permits a compact design which is protected against external influences. Thus, for example, the drive wheel of the first actuating drive can have a conical friction element which engages axially in a counter-friction element, which is designed as an inner cone and is at least partly arranged within the second drive wheel.

A particularly compact design can be realized—in particular in the last-mentioned embodiment—in that the drive wheels are arranged within the axial extent of the actuating drives, i.e. are not attached so as to protrude axially on one side.

It is preferred that the friction element and/or the counter-friction element have/has a friction pad. The friction and counter-friction element preferably have a metallic main body, for example made from steel. In order to avoid metal-to-metal contact, a coating or a pad for producing a friction pairing with a defined friction force can preferably be applied, for example made from sintered materials, metal and/or ceramic friction materials, composite materials or the like. This can ensure a defined, reproducible clutch torque.

It can be provided that an actuating drive has a spindle drive. In this case, in a manner known per se, a threaded spindle engages into a spindle nut, and a relative rotating drive via a drive wheel connected to the threaded spindle or the spindle nut. It is possible for the spindle nut to form the drive-side drive element of the actuating drive, and the threaded spindle to form the output-side output element, which is linearly adjustable relative thereto, or vice versa.

It is possible for an actuating drive to have a ball ramp arrangement, wedge disc arrangement or a tilting pin arrangement. In the case of a ball ramp arrangement, also referred to as ramp bearings, the drive and output elements preferably have cam disks with raceways or ramps which are inclined against the axis and between which balls which can roll in the circumferential direction are arranged. Owing to the balls rolling on the ramps, a relative rotation causes the output element to be axially displaced relative to the drive element. In a tilting pin arrangement which is known per se, tilting pins are arranged between the drive element and output element and are each supported in the circumferential direction in such a way that, in the event of a relative rotation, they are inclined to a greater or lesser extent against the axis depending on the direction of rotation, as a result of which the distance between the drive element and output element is also adjustable.

In the actuating device, two identically acting actuating drives can be combined with each other as first and second actuating drives, for example two spindle drives. It is also possible to combine two different designs together, for example a ball ramp arrangement as the first actuating drive, and a spindle drive as the second actuating drive, for adjusting the air gap. The respective characteristic properties of each design can be optimally exploited. For example, a non-linear adjustment characteristic and/or at least partially self-locking properties, and/or a defined dead center or extended position, which permits a defined adjustment path, can be realized with little complexity using a ball ramp arrangement. The implementation of the aforementioned positive properties may at least partially require a precise specification of the air gap, which can be implemented without any problems using the friction clutch according to the invention.

A brake device according to the invention can comprise an actuating device and a brake part which is connected thereto, is adjustable along an axis by the actuating device and can be brought into brake engagement with a counter-brake part, wherein the actuating device has a first actuating drive and a second actuating drive which is coupled in series thereto, wherein the first actuating drive has a rotationally drivable first drive wheel and the second actuating drive has a rotationally drivable second drive wheel which is coaxial with the first drive wheel, wherein a clutch device is arranged between the first drive wheel and the second drive wheel.

The actuating device is drivable by at least one electric actuating motor. The latter is preferably in gear engagement with at least one drive wheel. Preferably, one actuating motor can be provided for each of the first and the second drive wheel. According to the invention, the actuating motor or motors can be activated by a wheel brake control unit assigned to the brake device.

In the last-mentioned embodiment of the brake device, it can preferably be provided that the clutch device is configured as a friction clutch having a friction element which, during engagement of the clutch, is connectable in a friction-fitting manner to a counter-friction element.

This makes it possible to implement the advantages explained above in conjunction with the brake system.

In order to implement the method according to the invention, it can be provided that the brake device has an actuating device which can be coupled to an actuating motor and comprises a first actuating drive and a second actuating drive coupled in series thereto, and which acts on a brake part which can be brought into brake engagement in the direction of an axis with a counter-brake part, wherein the first actuating drive has a rotationally drivable first drive wheel, to which a first drive torque can be applied for actuation, and the second actuating drive has a rotationally drivable second drive wheel which is coaxial with the first drive wheel and to which a second drive torque can be applied for actuation, wherein a clutch device is arranged between the first drive wheel and the second drive wheel, wherein it is provided according to the invention that the clutch device is configured as a friction clutch and has a predefinable clutch torque which, when exceeded, causes the first drive wheel to slip relative to the second drive wheel, wherein, for actuation of the first actuating drive, the first drive wheel and the second drive wheel are driven synchronously, with the result that the second actuating drive remains non-actuated, and, for actuation of the second actuating drive, the second drive wheel is driven, and the first drive wheel is stopped relative thereto, with the result that the friction clutch slips and the first actuating drive remains non-actuated.

The features mentioned above in conjunction with the brake device according to the invention can be used individually and in combinations for implementing the method according to the invention.

For adjusting the first actuating drive, an actuating torque can be coupled into the first drive wheel by means of a first electric actuating motor and, accordingly, the second actuating drive can be driven by a second electric actuating motor.

During the normal brake mode, the first and second drive wheels are rotated synchronously. This can take place, firstly, by the first and second drive wheels being driven by the first and second actuating motors with synchronized drive torques. Secondly, the second drive wheel can be entrained synchronously by the clutch device during driving of the first drive wheel, as long as the transmitted drive torque remains below the clutch torque. In this operating mode, the second actuating drive remains non-actuated and idly revolves as a whole together with the brake element.

In the method, when the clutch torque is exceeded, in order to adjust the air gap, the clutch device can slip continuously and uniformly. This can be implemented, for example, in that the drive wheel of the first actuating drive is stopped, for example by a brake or a corresponding actuation of the first drive motor, while a second driving torque, which is greater than the clutch torque, is applied to the second drive wheel by the second drive motor. As a result, the second drive wheel is rotated relative to the first drive wheel and, by actuating the second actuating drive, the air gap can be continuously and finely adjusted, with the result that continually progressive wear on the brake element or the brake pad can be optimally compensated for.

It is possible for the first drive wheel and the second drive wheel to be coupled in a torque-transmitting manner by the friction clutch in order to produce a synchronous drive.

In this case, synchronous driving of the two drive wheels by the actuating motors is not required. Any torque differences can be compensated for within predetermined tolerances.

It can be advantageously provided that a higher clutch torque is specified when the first actuating drive is actuated than when the second actuating drive is actuated. The first actuating drive is actuated by synchronous driving of the first and second drive wheels. The friction element and the counter-friction element are preloaded against each other by the spring force of the spring element, and in addition, the adjustment force of the first actuating drive acts in opposition to the spring force. This results in a relatively high clutch torque. If, in contrast, only the second drive wheel is rotated to adjust the air gap, the spring force alone is in action, with the result that a lower clutch torque is set. This facilitates the adjustment of the air gap.

### DESCRIPTION OF THE DRAWINGS

Advantageous embodiments of the invention will be described in more detail in the following text with reference to the drawings, in which, in detail:

FIG. 1 shows a schematic perspective view of a brake device according to the invention,

FIG. 2 shows a lateral view of the brake device according to FIG. 1,

FIG. 3 shows an exposed schematic perspective view of the actuating device according to the invention of the brake device according to FIG. 1,

FIG. 4 shows a section Q-Q through the brake device according to FIG. 1,

FIG. 5 shows an exposed schematic perspective illustration of the first actuating drive of the brake device according to FIG. 1,

FIG. 6 shows an enlarged detailed view of the actuating device from FIG. 4, and

FIG. 7 shows a longitudinal section through a motor mounted on the drive carrier of the brake device.

### EMBODIMENTS OF THE INVENTION

In the various figures, identical parts are always provided with the same designations, and will therefore generally also be named or mentioned only once in each case.

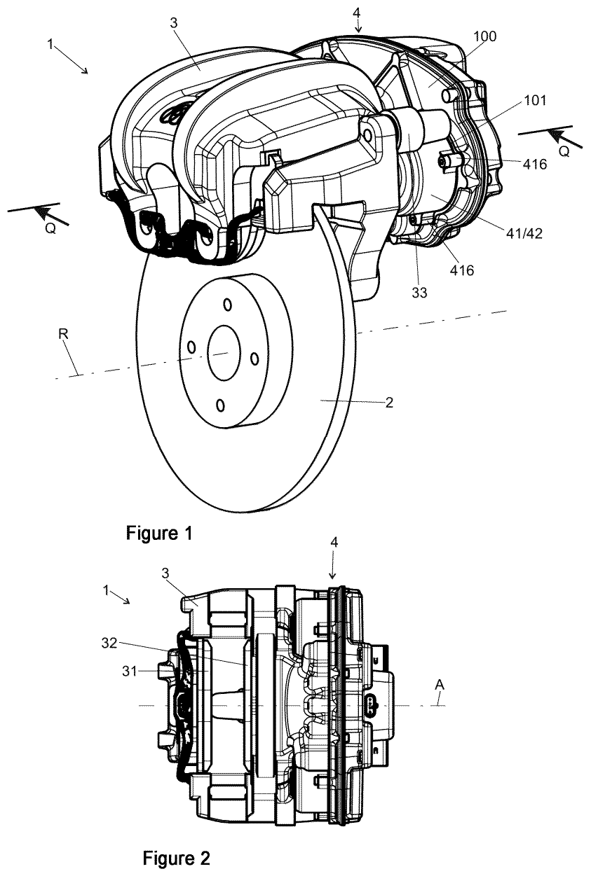

FIG. 1 shows a brake device according to the invention as a whole, in the form of a disk brake. This brake device comprises a brake disk 2 which forms a counter-brake part and is connected to a vehicle wheel which is rotatable about a wheel axis R and is not illustrated here. A brake caliper 3 reaches around the two axial end surfaces of the brake disk 2.

The brake disk 2 is designed here as an unventilated brake disk made from solid material. As an alternative, it can also be designed as an internally ventilated brake disk.

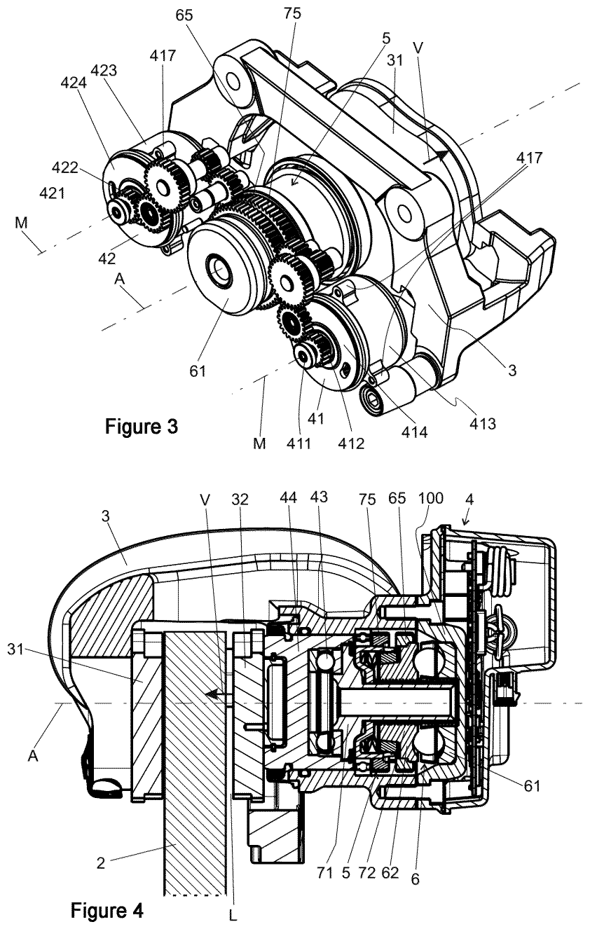

An electric brake actuator 4 according to the invention, which is shown in FIG. 3 in a separate, exposed schematic perspective view, and is explained in detail in FIGS. 4 to 6, is attached to the brake caliper 3.

The brake actuator 4 comprises an actuating device 5 which extends axially in the direction of an axis A which lies parallel to the wheel axis R and indicates the adjustment direction V of the actuating device 5.

As can be seen in the sectional illustration of FIG. 4 along the axis A, the brake disk 2 is arranged axially between two brake pads 31 and 32. The one brake pad 31 is fixedly supported on the brake caliper 3 on the side facing away from the brake actuator 4. The other brake pad 32, which forms a brake part within the meaning of the invention, is attached to the actuating device 5 and is adjustable by the latter in the axial adjustment direction V, indicated by the axis A, toward the brake disk 2 to produce the brake engagement, as indicated in FIG. 4 by the arrow.

In the non-actuated state of the brake device 1, an axial air gap L, which is shown schematically with an exaggerated width in FIG. 4, is located between the brake disk 2 and the adjustable brake pad 32.

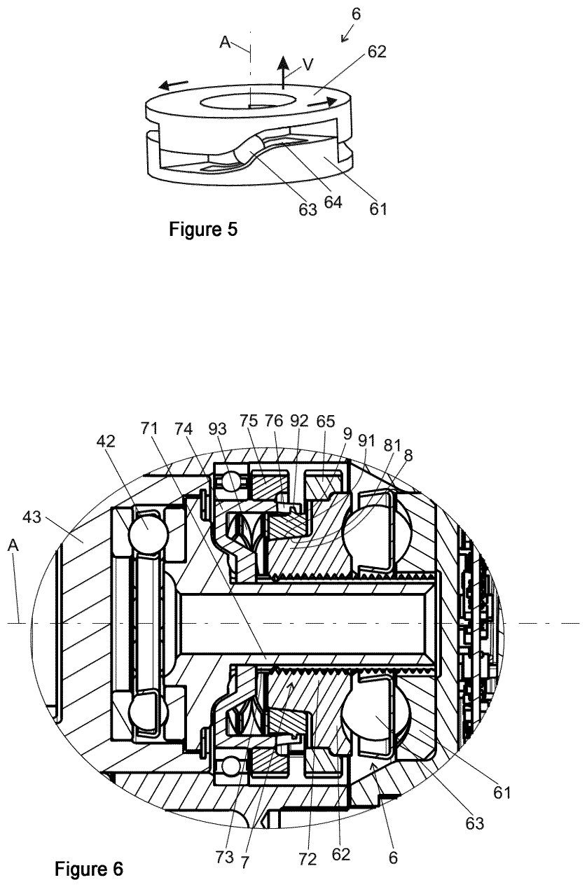

The construction of the actuating device 5 is illustrated in FIG. 4 and in the enlarged detail thereof in FIG. 6.

The actuating device 5 comprises a first actuating drive 6, which has a ball ramp arrangement (also called a ramp bearing), and a second actuating drive 7, which is coupled axially (with regard to the axis A) thereto in series and has a spindle drive.

The first actuating drive 6, which is formed in the example shown as a ball ramp arrangement or ramp bearing, comprises a drive-side cam disk 61, which is supported axially on the brake actuator 4 fixedly for rotation therewith, and an output-side cam disk 62. Balls 63 are arranged between the cam disks 61 and 62. As can be seen in the schematically exposed view of FIG. 5, the cam disks 61 and 62 have mutually axially opposite ramp-like raceways 64, which lie obliquely with respect to the axis A and between which balls 63 can roll. A rotation of the output-side cam disk 62, in FIG. 5 above, relative to the fixed drive-side cam disk 61—as schematically indicated by the curved arrows—leads to a linear adjustment of the output-side cam disk 62 in the adjustment direction V parallel to the axis A. Thus, as shown in FIG. 4, the brake pad 32 can be brought into brake engagement by actuating the first actuating drive 6.

The cam disk 62 is connected to a coaxial gearwheel 65, which is in the form of a spur gear and forms a drive wheel in the context of the invention.

The gearwheel 65 is in gear engagement with a first electric actuating motor 41, which is also referred to as a motor 41 for short. This enables the rotating drive of the cam disk 62 and thus actuation of the first actuating drive 6.

The second actuating drive 7, which, in the example shown, is in the form of a spindle drive, has, on the output side, a threaded spindle 71 which engages into the internal thread of a drive-side spindle nut 72. This internal thread is formed in the output-side cam disk 62 of the first actuating drive 6, with the result that the functions of the output-side cam disk 62 and the drive-side spindle nut 72 are combined in one component.

The threaded spindle 71 is connected via a hub part 74 to a coaxial gearwheel 75 which is rotatably mounted in axially fixed form in the brake actuator 4. The threaded spindle is coupled in a torque-locked but axially displaceable manner to the gearwheel 75 via drivers 73 which can have, for example, radially projecting protrusions or teeth which engage axially movably into axial slots of the hub part 74.

The gearwheel 75, like the gearwheel 65, can be designed as a spur gear and is arranged coaxially adjacently with respect to the latter. This gearwheel 75 is in gear engagement with a second electric actuating motor 42, which is also referred to as a motor 42 for short. This enables the rotating drive of the threaded spindle 71 and thus actuation of the second actuating drive 7.

The threaded spindle 71 is axially connected via a thrust bearing 43, for example, as shown, an axial rolling bearing, to a thrust member 44, to which the displaceable brake pad 32 is attached, as can be seen in FIG. 4. The thrust member 44 can also be referred to as a piston.

The clutch device has a friction element 8 which, as a coaxial, conical shoulder, is directed from the cam disk 62 toward the second actuating drive 7. The conical shoulder has a conical friction surface 81 arranged on the outer side of an outer cone. The friction element 81 can preferably be formed integrally with the cam disk 62/spindle nut 72.

When the clutch is engaged, the friction element 8 is coupled in a frictionally locking manner to a counter-friction element 9. Here, the conical shoulder axially enters a corresponding conical opening in the counter-friction element 9, which has a conical friction surface 91 arranged in an inner cone. When the clutch is engaged, the friction surface 81 and the counter-friction surface 91 lie in a frictionally locking manner against each other, as can be clearly seen in FIG. 6.

The counter-friction element 9 is coupled in a torque-locked but axially displaceable manner to the gearwheel 75 via drivers 92 which engage into corresponding slots 76 in the hub part 74 or in the gearwheel 75.

A spring element 93 is arranged between the gearwheel 75 or the hub part 74, which is connected thereto, and the counter-friction element 9. Owing to its axially acting spring force, the counter-friction element 9 is elastically braced against the friction element 8. A defined clutch torque of the friction clutch according to the invention formed by the friction element 8 and the counter-friction element 9 is produced as a result.

FIG. 3 shows how the two motors 41, 42 and the actuating device 5 are arranged relative to the brake caliper 3. The drive carrier 100 is omitted in this diagram for an improved overview.

Each of the motors 41, 42 has a motor shaft 411, 421 which can be rotationally driven about a motor axis M and lies parallel to the axis A. A gearwheel 412 or 422 is mounted on each of these, which is in each case in gear engagement with the gearwheel 65 or 75 of the actuating device 5.

Each motor 41, 42 has a motor housing 413, 423 which, in the example shown, has a cylindrical basic shape. It is of cup-shaped design and is closed on its axial end side facing the viewer in FIG. 3 in each case by means of a bearing cap 414, 424, wherein the motor shaft 411, 412 bearing a rotor of the motor 41 is in each case mounted in the bearing cap 414, 424 and protrudes axially from this.

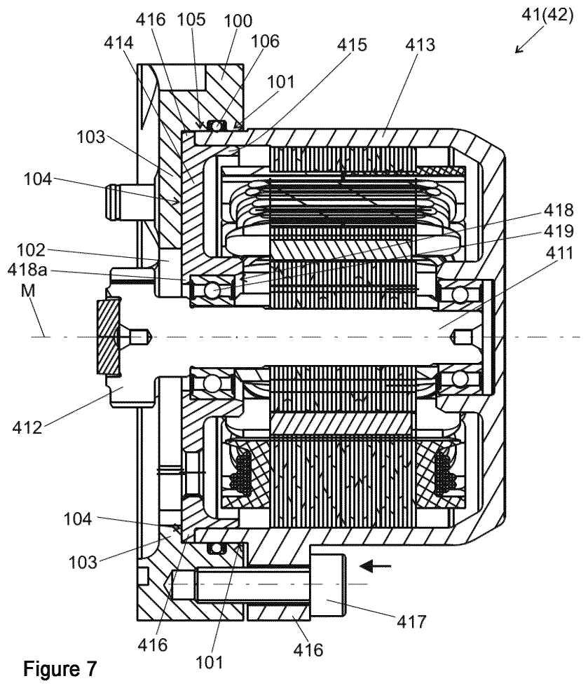

FIG. 7 shows a longitudinal section along the motor axis M through the motor 41 and 42, wherein, for improved clarity, only the designations for the motor 41 are added, which are correspondingly also present in the other motor 42, however.

The drive carrier 100 has a recess 101 which comprises an opening 102 passing through the drive carrier 100. A projection 103 projecting in a stepped manner inwardly radially into the opening cross section has an axial support surface 104 which is directed against the motor 41. The recess 101 is radially outwardly delimited by an inner surface 105 running around coaxially with respect to the motor axis M.

The inner surface 105 is adapted to the external diameter of the motor housing 413 in such a way that it can be inserted axially into it and is held and supported in a positively locking manner radially, i.e. transversely with respect to the motor axis M.

The bearing cap 414 is inserted with an axial shoulder 415 axially from the front into the motor housing 413. With its front end side—which, by definition, points to the front and in FIG. 7 to the left—the bearing cap 414 lies axially against the support surface 104 of the recess 101.

The bearing cap 414 has, furthermore, a peripheral, radially projecting collar 416 which is arranged axially between the motor housing 413 and the support surface 104.

The motor housing 413 has flange elements 416 which project radially outward beyond the recess 101 with axially continuous flange holes, through which the screws 417 serving as fastening elements are guided and are screwed into corresponding threaded bores in the drive carrier 100.

By screwing in and tightening the screws 417, the motor housing 413 is fixed to the drive carrier 100 and braced with it. Here, the bearing cap 414 together with the motor housing 413 is axially braced against the support surface 104 (in FIG. 7, to the left as indicated by the arrow), and is at the same time axially pressed into the motor housing 413 (in FIG. 7, to the right) and fixed. Thus, the screws 417 have a dual function for fixing the motor 41 to the drive carrier 100 and for connecting the bearing cap 414 to the motor housing 413. Here, the support surface 104 and the inner surface 105 provide a defined orientation of the motor 41 relative to the drive carrier 100.

Furthermore, an O-ring 106 made from an elastic elastomer or rubber material can be arranged between the motor housing 413 and the inner surface 105, for example as shown in a groove running around on the inside in the inner surface 105. This is elastically clamped in there in the radial direction and ensures that the motor housing 413 is held in a frictionally locking manner in the recess 101 by simple axial insertion—in FIG. 7, in the direction of the arrow to the left. In addition, the motor 41 can be sealed against the drive carrier 100 in this way.

The bearing cap 414 has a receiving opening 418, through which the motor shaft 411 extends, wherein a bearing 419 for the rotatable mounting of the motor shaft 411 is arranged between the motor shaft 411 and the receiving opening 418 opposite the bearing cap 414, which bearing is designed as an anti-friction bearing, more precisely as a radial groove ball bearing. The receiving opening 418 has an inwardly projecting shoulder portion 418a, against which the bearing 419 lies in the direction of the motor axis M and on which it is supported.

### LIST OF DESIGNATIONS

1 Brake device
100 Drive carrier
101 Recess
102 Opening
103 Projection
104 Support surface
105 Inner surface
106 O-ring
2 Brake disk
3 Brake caliper
31, 32 Brake pad
33 Fastening bolt
4 Brake actuator
41,42 Motor (actuating motor)
411, 421 Motor shaft
412, 422 Gearwheel
413, 423 Motor housing
414, 424 Bearing cap
415, 425 Shoulder
416, 426 Flange element
417, 427 Screw
418 Receiving opening
418a Shoulder portion
419 Bearing
43 Thrust bearing
44 Thrust member
5 Actuating device
6 First actuating drive
61 Cam disk
62 Cam disk (integrated with spindle nut 72)
63 Ball
64 Raceway
65 Gearwheel
66 Ball cage
67 Depression
7 Second actuating drive
71 Threaded spindle
72 Spindle nut (integrated with cam disk 62)
73 Driver
74 Hub part
75 Gearwheel
76 Slot
8 Friction element
81 Friction surface
9 Counter-friction element
91 Counter-friction surface
92 Driver
93 Spring element
A Axis
R Wheel axis
V Adjustment direction
L Air gap
M Motor axis

1-10. (canceled)

11. An electromechanical brake device for a motor vehicle, comprising:
a drive carrier to which an electric motor and an actuating device are attached, which actuating device is coupled in a geared manner to a motor shaft and by which a brake part is adjustable;
wherein the motor has a motor housing, in which the motor shaft which extends in the axial direction is mounted in a front-side bearing cap and projects axially from it;
wherein the motor housing is fixed to the drive carrier;
wherein the drive carrier has a recess, in which the motor housing can be received in a positively locking manner in the axial and radial direction;
wherein the motor housing can be braced on the front side against an axial support surface of the recess.

12. The brake device as claimed in claim 11, wherein the support surface is formed on a projection which projects radially inward in the recess.

13. The brake device as claimed in claim 11, wherein the bearing cap is attached on the front side to the motor housing.

14. The brake device as claimed in claim 11, wherein the bearing cap is axially supported against the support surface.

15. The brake device as claimed in claim 11, wherein the bearing cap can be braced between the support surface and the motor housing.

16. The brake device as claimed in claim 11, wherein the motor housing has a flange element which is axially spaced apart from the end side and radially projects beyond the recess.

17. The brake device as claimed in claim 11, wherein the motor housing at least partially has a hollow cross section, on which the bearing cap can be fixed in a positively locking manner.

18. The brake device as claimed in claim 11, wherein the motor housing, the bearing cap and/or the drive carrier comprise/comprises a cast part.

19. The brake device as claimed in claim 11, wherein an elastic holding element and/or sealing element are/is arranged between the recess and the motor housing.

20. The brake device as claimed in claim 11, wherein the drive carrier has at least two recesses.
